(19) United States
(12) Patent Application Publication
(10) Pub. No.: US 2008/0192472 A1
(43) Pub. Date: Aug. 14, 2008

(54) Light-Emitting Device

(75) Inventors: Marcus Antonius Verschuuren, Eindhoven (NL); Martinus Petrus Joseph Peeters, Eindhoven (NL); Theodora Antonia Petra Maria Keursten, Eindhoven (NL); Jan De Graaf, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/911,228

(22) PCT Filed: Apr. 12, 2006
(86) PCT No.: PCT/IB06/51128

§ 371 Date: Oct. 11, 2007

(30) Foreign Application Priority Data
Apr. 14, 2005 (EP) 05102963.5

(51) Int. Cl. F21S 6/00; B29C 65/52

(52) U.S. Cl. 362/257; 156/60

(57) ABSTRACT

The present invention relates to a light-emitting device comprising at least one light-emitting diode (LED) chip (12), and an inorganic optical element (14) being connected to the chip(s) by means of a bond (16). The light-emitting device is characterized in that the bond is of a bonding material comprising a matrix including silicon and oxygen atoms with hydrocarbon groups directly bonded to at least a fraction of the silicon atoms. Such inorganic-organic bonding material has very high photo and thermal stability. As a result, high power and high lumen LED chips can be deployed, whereby high brightness light-emitting devices can be realized. The present invention also relates to a method for the manufacture of such light-emitting device.

The present invention relates to a light-emitting device comprising at least one light-emitting diode (LED) chip and an inorganic optical element being connected to the chip(s) by means of a bond, and a method for the manufacture of such a light-emitting device.

A technical challenge when using LEDs is to efficiently extract light generated by the LED chip in order to obtain a light-emitting device having sufficient efficacy. A classical approach in this context involves the use of primary extraction optics, i.e. optical domes provided on the LED chips, which optical domes extract the light based on their refractive properties. The materials of these optical domes are often based on silicones and polymers (such as PMMA). However, these optical domes have limited photo-thermal stability, which limits the power of the used LED chips, which in turn limits the lumen power of the light-emitting device.

An alternative approach is to use inorganic optical elements for the extraction of light from LED chips. The materials of such optical elements can for example be polycrystalline ceramic materials or glass. Such inorganic optical elements have much higher photo-thermal stability, which allows for the use of high power LED chips, which in turn enables light-emitting devices with high lumen power and output.

However, high power LED chips may dissipate significant heat and the radiation may be intense. In this context, the bond between the LED chip(s) and the inorganic optical element, which bond forms a junction coupling light from the LED chip(s) into to the inorganic optical element, is an important aspect. The bond or junction should exhibit high photo-thermal stability itself, so that it is not a performance limiting factor in the light-emitting device, and so that it is possible to benefit from the inorganic optical element. Thus, there is a need for a light-emitting device where the bond between the high power LED chip and the inorganic optical element can withstand the load and stress it is exposed for.

It is an object of the present invention to overcome this problem, and to provide an improved light-emitting device.

This and other objects that will be evident from the following description are achieved by means of a light-emitting device, and a method for the manufacture of such a light-emitting device, according to the appended claims.

According to an aspect of the invention, there is provided a light-emitting device comprising at least one light-emitting diode (LED) chip, and an inorganic optical element being connected to the chip(s) by means of a bond, wherein the bond is of a bonding material comprising a matrix including silicon and oxygen atoms with hydrocarbon groups directly bonded to at least a fraction of the silicon atoms. Preferably, the bonding material comprises a silsesquioxane having the formula SiO_{1.5}R, where R is for example methyl, ethyl or phenyl.

Such inorganic-organic bonding material has very high photo and thermal stability. The silicone-carbon bond is thermally stable up to about 400° C. in air and stable for wavelengths down to about 350 nm. As a result, high power LED chips can be deployed, whereby high brightness light-emitting devices can be realized. Also, the matrix has a relatively high elasticity due to the fact that the silicon atoms are only threefold cross-linked to each other.

It should be noted that similar bonding materials are known per se, for example from the document U.S. Pat. No. 5,991,493. However, when applied as a bonding material between (high power) LED chips and an inorganic optical element, there is the unexpected additional effect that the material has very high photo and thermal stability, therefore making it very suitable as a bond between LED chips and inorganic optical elements.

The bond is preferably at least partially optically transmissive or transparent for coupling out light from the LED chip(s) and into the inorganic optical element.

The bonding material is made from a precursor material, which precursor material preferably comprises organically modified silane. Preferably, the silane is mono-organically modified using for example methyl, ethyl or phenyl as organic modifier. Mono-organically modified is to be construed as one of the four covalent bonds of the silicon is a Si-C bond. In this case, the remaining three bonds are Si-O bonds. An example of a preferred precursor material is a sol gel material comprising methyl-tri-methoxy-silane (MTMS), which is a mono-methyl-modified silane. After suitable processing, MTMS results in a bonding material comprising a matrix having the basic structure CH₃—Si—O_{1.5} (i.e. a silsesquioxane). The matrix has a relatively high elasticity due to the fact that the silicon atoms are only threefold cross-linked to each other. Other suitable precursor materials include T-resins, such as Silres 610 or Silres 603 from Wacker Chemie GmbH.

The bond connecting the LED chip(s) to the inorganic optical element can further comprises an oxide including at least one element selected from the group consisting of Si, Al, Ga, Ti, Ge, P, B, Zr, Y, Sn ,Pb, and Hf. The oxide serves to increase the bond's index of refraction, which in turn enhances the light coupling capability of the bond.

Also, the bond can further comprise phosphorescent particles, for example YAG:Ce. The bond comprising phosphorescent particles is preferably combined with LED chips emitting blue light or UV(A) light, resulting in a called phosphor converted LED. In a phosphor converted LED, at least some of the blue radiation from the LED chip is converted into for example yellow light by the phosphorescent particles. Together, the non-converted blue light and the yellow light generates a white light. Thus, in this case, the bond functions both as an adhesive and as a phosphor encapsulate. Also, the above-mentioned bonding material shows very stable performance under blue fluxes.

According to another aspect of the invention, a method for the manufacture of a light-emitting device is provided. The method comprises providing a light-emitting diode (LED) chip and an inorganic optical element, preparing a precursor bonding material comprising organically modified silane, applying said bonding material to at least one of the chip and optical element, at least partly hydrolyzing the bonding material, bonding the chip and optical element using the applied bonding material as adhesive, and curing the bonding material. This method offers similar advantages as obtained with the previously discussed aspect of the invention.

These and other aspects of the present invention will now be described in more detail, with reference to the appended drawings showing a currently preferred embodiment of the invention.

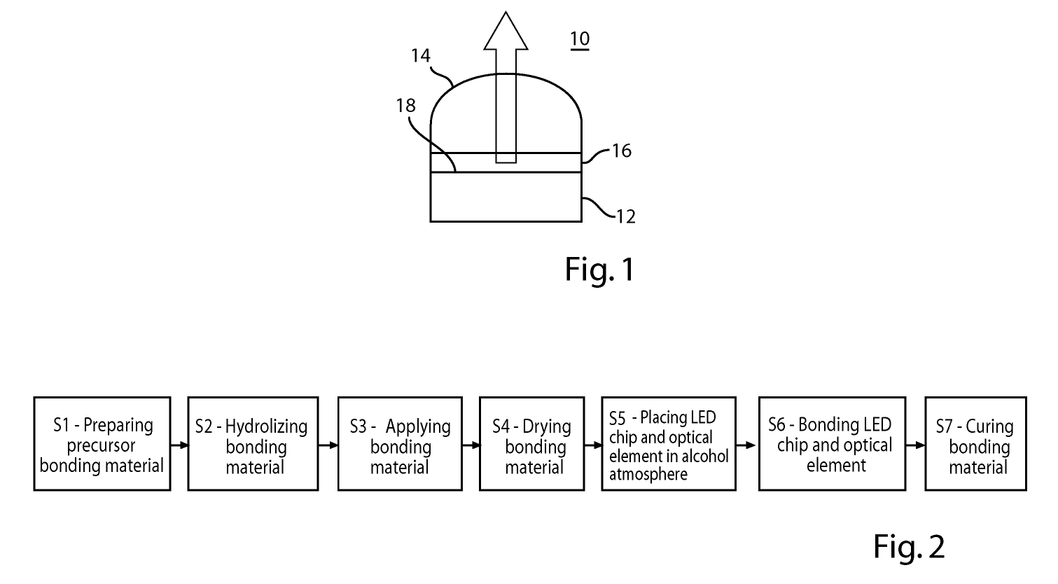

FIG. 1 is a side view of a light-emitting device according to an embodiment of the present invention, and

FIG. 2 is flow chart describing a method for the manufacture of a light-emitting device according to an embodiment of the invention.

FIG. 1 shows a light-emitting device 10 according to an embodiment of the invention. The light-emitting device 10 can for example be used for illumination purposes. The light-emitting device 10 comprises a light-emitting diode (LED) chip 12, which is connected to an inorganic optical element 14 by means of a bond 16. Here, the inorganic optical element 14 is bonded to the light-emitting side 18 of the LED chip 12.

The inorganic optical element 14 in FIG. 1 is an optical dome, for extracting light from the LED chips. However, the inorganic optical element can adopt other forms, for example it can be designed as a plate. The LED chip 12 is preferably of flip chip type and mounted on a substrate (not shown).

The bond 16 is at least partially optically transmissive or transparent, whereby upon operation of the light-emitting device 10, light generated by the LED chip 12 is coupled via the bond 16 to the optical element 14, which optical element in turn serves to extract the generated light from the LED chip 12.

According to an embodiment of the invention, the organic-inorganic bond is of a bonding material comprising a matrix including preferably a silsesquioxane. The bond exhibits high photo and thermal stability (the working temperature for a LED chip can be about 100° C.). As a result, high power and high lumen LED chips can be deployed, whereby high brightness light-emitting devices can be realized.

A method for the manufacturing of a light-emitting device such as the device 10 shown in FIG. 1 will now be described in detail in relation to FIG. 2.

First a precursor material is prepared (step S1). The precursor material comprises organically modified silane. An example of a preferred material is a sol-gel material comprising methyl-tri-methoxy-silane (MTMS), which is a mono-methyl-modified silane having the formula CH₃—Si(CH₃—O)₃. Another suitable precursor material is a T-resin like Silres 610. Also, silanes modified with other organic groups such as ethyl or phenyl can be employed.

The precursor material can further comprise nanoparticles of Si-, Al-, Ga-, Ti-, Ge-, P-, B-, Zr-, Y-, Sn- ,Pb-, or Hf oxides, which serve to increase the index of refraction of the fmal bond. The oxide can have an outer silica layer, which prevents the photo-thermal degradation of the surrounding matrix.

The precursor sol-gel material is subjected to hydrolysis (step S2), where after it is applied to at least one of a LED chip and an inorganic optical element (which are due to be bonded together) (step S3) forming a coating on these parts.

Network formation (condensation) continues when the precursor sol-gel material is applied on the parts (i.e. the LED chip and inorganic optical element) and this network formation progresses during curing. During this condensation the network shrinks, the solid content increases and volatile components are released.

Preferably the parts are bonded at a state of the sol-gel material when there is as high solid content as possible, but the material is still somewhat flexible and has reactive groups/sites (gel state). This allows for compensation of the non-flatness of the parts to be bonded. This high solid content gel-state can be obtained in a controlled way by first applying the sol-gel on the parts to be bonded and have the sol-gel dried almost completely (step S4). This will remove most of the alcohol and water from the coating and from the network. However, in this state the coating is not flexible enough anymore to deform and compensate the non-flatness of the parts to be bonded. By placing these coated parts in an alcohol atmosphere (step S5) the sol-gel will absorb some alcohol, swell and become flexible again. This amount of swelling can be controlled by the time the sol-gel is exposed to the alcohol atmosphere. An advantage of this procedure is that little amount of volatiles need to be removed by diffusion through the matrix during the subsequent curing .

The LED chip and the inorganic optical element parts are subsequently brought together and bonded together (step S6), optionally while being compressed, i.e. pressed against each other. As the sol-gel material is further cured (step S7), the remaining volatile components diff-use out of the sol-gel matrix. This curing is accomplished after bonding of the parts by slowly heating the sol-gel material, whilst applying pressure to both parts. The minimum temperature for the sol-gel curing is about 200° C. and this can be as high as 450° C. During curing the sol-gel will further condensate and density. This will lead to the desired properties like mechanical strength and index of refraction of the final bonding material.

The overall reaction when using MTMS is:

CH₃Si(OCH₃)₃+1.5 H₂O−CH₃SiO_{1.5}30 3CH₃OH

As an alternative to the swelling of the bonding material in an alcohol atmosphere mentioned above, the precursor material can comprise a high boiling solvent, whereby the bonding material is pre-dried before the bonding step. An advantage of this procedure is that it leaves the high boiling solvent as the last volatile to be removed by diffusion through the matrix during the subsequent curing. The solvent preferably has a boiling point in the range of 100 to 200° C. Also, the pre-dying can transform into curing in one heating step.

In order to decrease shrinkage of the MTMS sol-gel material upon conversion, the precursor material can further comprise colloidal silica. As a result the thermal expansion coefficient can be lowered, while maintaining a high elasticity. Such a material has good bonding properties and can accommodate stresses induced by the formation of the bonding material matrix itself and stresses of a thermal nature, like a mismatch in expansion coefficient between the bonded parts and/or the bond.

It is also possible to partly replace MTMS with TEOS (tetra-ethoxy-ortho- silicate, Si(OC₂H₅)₄), or titanium, zirconium or other high index precursors. In this case, the precursor material comprises both MTMS and e.g. TEOS. Further, there are less organic groups and the bonding material is assumed to be even more photo-thermally stable. The disadvantage of moving to a less organic system is the glue layer needs to be thinner.

The person skilled in the art realizes that the present invention by no means is limited to the preferred embodiments described above. On the contrary, many modifications and variations are possible within the scope of the appended claims. For example, even though one LED chip is shown in FIG. 1 above, plurality of LED chips can be bonded to the inorganic optical element, forming a multi-LED module.

1. A light-emitting device (10), comprising:
at least one light-emitting diode (LED) chip (12), and
an inorganic optical element (14) being connected to said chip(s) by means of a bond (16),
characterized in that
said bond is of a bonding material comprising a matrix including silicon and oxygen atoms with hydrocarbon groups directly bonded to at least a fraction of the silicon atoms.

2. A light-emitting device according to claim 1, wherein said bonding material comprises a silsesquioxane where the group directly bonded to silicon is an element selected from the group consisting of methyl, ethyl, and phenyl .

3. A light-emitting device according to claim 1, wherein said bonding material is formed from a precursor material, which precursor material comprises organically modified silane.

4. A light-emitting device according to claim 3, wherein said precursor material comprises mono-organically modified silane.

5. A light-emitting device according to claim 3, wherein said silane is modified by one element selected from the group consisting of methyl, ethyl, and phenyl.

6. A light-emitting device according to claim 3, wherein said precursor material comprises methyl-tri-methoxy-silane (MTMS).

7. A light-emitting device according to claim 3, wherein said precursor material is a sol-gel material.

8. A light-emitting device according to claim 3, wherein said precursor material comprises T-resin.

9. A light-emitting device according to claim 1, wherein said bond further comprises an oxide including at least one element selected from the group consisting of Si, Al, Ga, Ti, Ge, P, B, Zr, Y, Sn ,Pb, and Hf.

10. A light-emitting device according to claim 1, wherein said bond further comprises phosphorescent particles.

11. A light-emitting device according to claim 1, wherein said bond is at least partially transparent.

12. A light-emitting device according to claim 1, wherein said LED chip is adapted to emit one of blue light and UV(A) light.

13. A method for the manufacture of a light-emitting device, comprising:
providing a light-emitting diode (LED) chip and an inorganic optical element,
preparing a precursor bonding material comprising organically modified silane,
at least partly hydrolyzing the bonding material,
applying said bonding material to at least one of said chip and optical element,
bonding the chip and optical element using the applied bonding material as adhesive, and
curing said bonding material.

14. A method according to claim 13, further comprising, before said bonding:
completely or nearly completely drying said bonding material, and
placing said chip and optical element with bonding material in an alcohol atmosphere.

15. A method according to claim 13, wherein said precursor material further comprises a solvent, and wherein the method further comprises, before said bonding:
pre-drying the bonding material.
